(19) United States
(12) Patent Application Publication
(10) Pub. No.: US 2026/0163887 A1
(43) Pub. Date: Jun. 11, 2026

(54) Delegated Tenant Administration in a Cloud-Based System

(71) Applicant: Zscaler, Inc., San Jose, CA (US)

(72) Inventors: Vamshi Palkonda, Pleasanton, CA (US); Badam Ramesh, Hyderabad (IN); Palash Gupta, Hyderabad (IN); Gaganpreet Kaur, Mohali (IN); Vivek Bhatt, Bengaluru (IN)

(73) Assignee: Zscaler, Inc., San Jose, CA (US)

(21) Appl. No.: 19/055,772

(22) Filed: Feb. 18, 2025

(30) Foreign Application Priority Data
Dec. 11, 2024 (IN) 202441097842

(51) Int. Cl. H04L 9/40

(52) U.S. Cl. CPC H04L 63/105

(57) ABSTRACT

Systems and methods for delegated tenant administration in a cloud-based system include receiving a request to access a resource from a user device, wherein the resource is located in one of a public cloud and an enterprise network, and wherein the user device is associated with a user of a tenant of the cloud-based system; performing a policy lookup for determining policy governing access for the user to the resource, wherein the policy is based on a micro tenant associated with the tenant; providing a connection between the user device and the resource based on the policy and the micro tenant associated with the user.

### FIELD OF THE DISCLOSURE

The present disclosure generally relates to network and cloud security. More particularly, the present disclosure relates to systems and methods for delegated tenant administration in a cloud-based system.

### BACKGROUND OF THE DISCLOSURE

Administrators managing cloud-based services are responsible for enabling secure, seamless, and policy-driven access to private applications without exposing them to the public internet. Their duties include configuring application segments, defining access policies based on user identity and device posture, monitoring traffic flows, and troubleshooting connectivity issues. Advanced cloud services operate within a zero trust framework, requiring administrators to enforce the principle of least privilege and continuously verify users and devices before granting access to internal applications. In large corporations, these responsibilities become more complex due to the scale and diversity of the IT environment. Administrators must manage thousands of users, applications, and devices spread across multiple geographies, departments, and business units. This can present challenges, particularly in environments with legacy systems or inconsistent configurations. Thus, a more manageable architecture is required to allow the administrative duties of large organizations to be manageable.

### BRIEF SUMMARY OF THE DISCLOSURE

The present disclosure relates to systems and methods for delegated tenant administration in a cloud-based system. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving a request to access a resource from a user device, wherein the resource is located in one of a public cloud and an enterprise network, and wherein the user device is associated with a user of a tenant of the cloud-based system; performing a policy lookup for determining policy governing access for the user to the resource, wherein the policy is based on a micro tenant associated with the tenant; and providing a connection between the user device and the resource based on the policy and the micro tenant associated with the user.

The steps can further include determining a micro tenant to which the user belongs prior to the policy lookup. The tenant can include a plurality of micro tenants with a plurality of users assigned thereto, wherein each of the plurality of micro tenants includes specific resources and policies. Each of the plurality of micro tenants can be managed by a specific scope administrator, wherein a scope administrator is allowed to manage only a specific micro tenant of the plurality of micro tenants. The tenant can include a global admin, wherein the global admin is allowed to manage a default tenant and each of the plurality of micro tenants. The tenant can include a default tenant and a plurality of micro tenants, wherein the policy lookup is performed in a top-down manner. The connection can be provided via a private access service of the cloud-based system, wherein the connection is between an agent application executing on the user device and an application connector associated with the resource.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of an embodiment of the private access system.

FIG. 6 is a diagram showing a tenant's administrative architecture with and without DTA.

FIG. 7 is a flowchart of a process for delegated tenant administration in a cloud-based system.

### DETAILED DESCRIPTION OF THE DISCLOSURE

Again, the present disclosure relates to systems and methods for delegated tenant administration in a cloud-based system. The Delegated Tenant Administration (DTA) system manages large and complex organizations by allowing different parts, known as Micro Tenants (MTs), to operate independently within a single deployment. This system enables the delegation of administrative responsibilities to various business units or departments, providing granular control over application access and security policies while maintaining centralized oversight. DTA works by segmenting the organization into MTs based on logical divisions such as locations, departments, or business units. Each MT manages its own resources and administrative controls. Users are authenticated via the organization's identity provider (IDP) and mapped to their respective MT based on criteria like authentication domains or attributes (country, department, location), System for Cross-domain Identity Management (SCIM) and Identity Provider (IDP) groups, and Security Assertion Markup Language (SAML) attributes. This mapping determines the application segments and policies applicable to them. MTs configure and manage their own application segments and access policies. Administrators define which applications are accessible and under what conditions, tailoring policies to their segment's needs. Shared application segments allow users from different MTs to access resources, with the receiving MT's administrator creating policies to permit access. Once access policies are validated, secure connections are established, and sessions are continuously monitored, dynamically enforcing policies based on changes in user context or device posture. Global Admins maintain overall control, updating infrastructure components and managing IDPs, while Scope Admins manage their designated MTs to align with operational needs. Each of the MT's configuration can be isolated and not visible across other MTs. An MT administrator can perform all of the configurations that are available at the tenant level.

### § 1.0 Cybersecurity Monitoring and Protection Examples

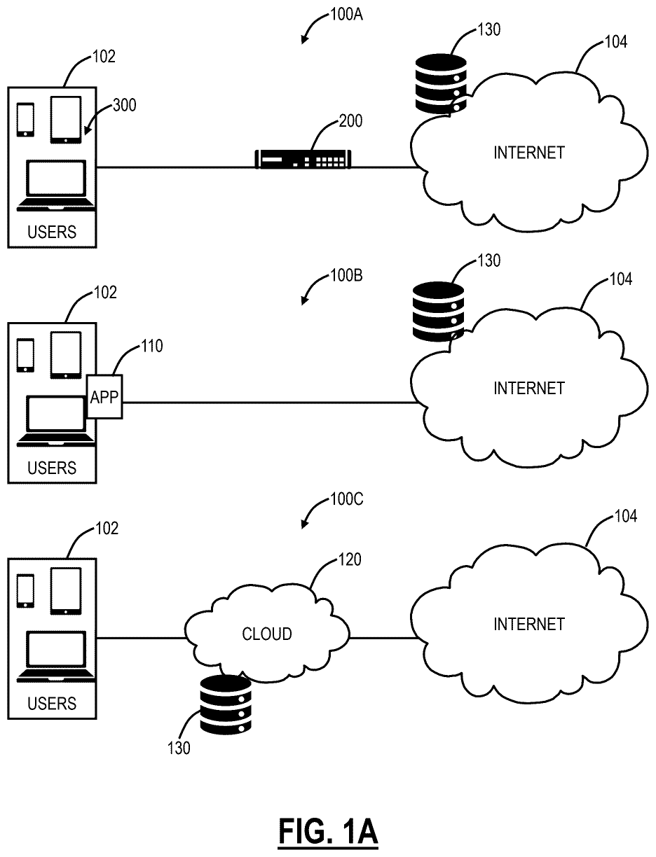

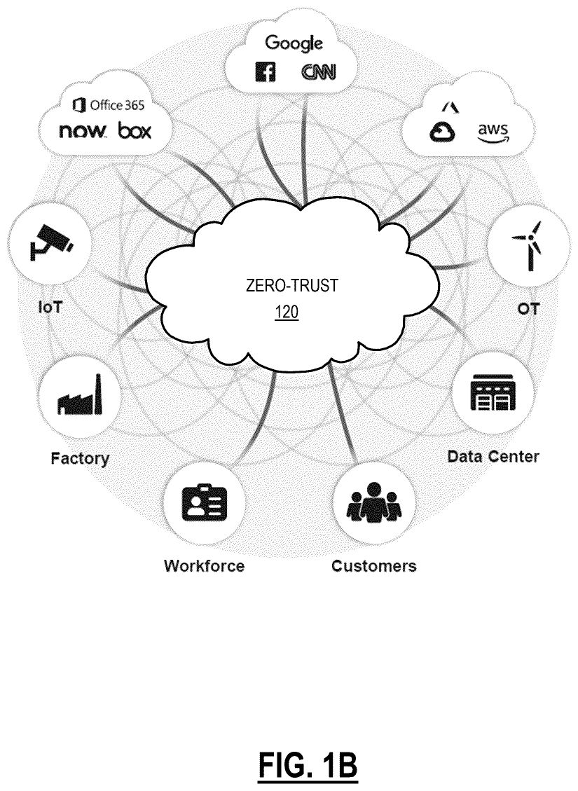

FIG. 1A is a network diagram of three example network configurations 100A, 100B, 1000 of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

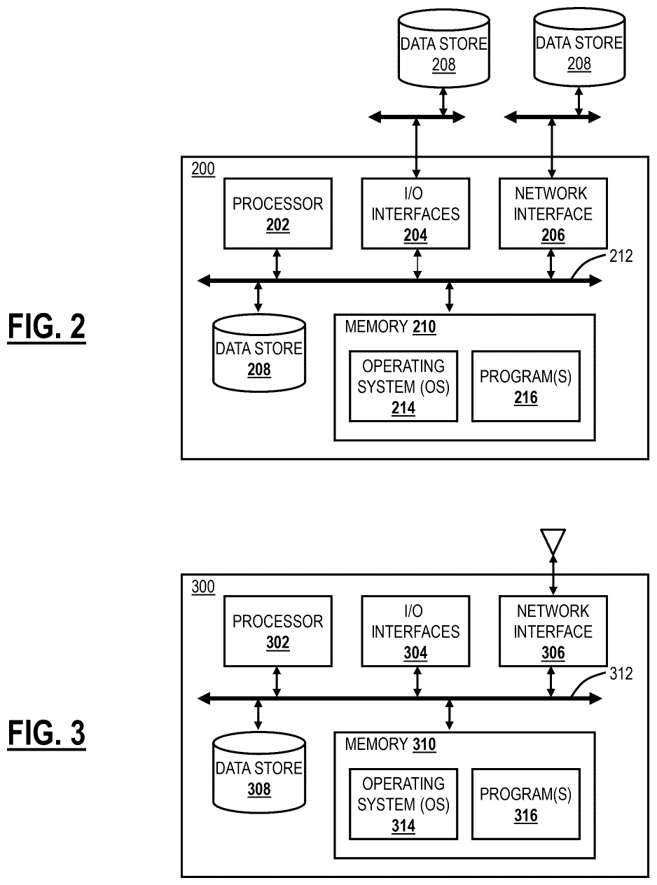

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 1000, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 1000 includes a cloud service 120 configured to monitor the endpoint 102 and perform security-as-a-service. Of course, various embodiments are contemplated herein, including combinations of the network configurations 100A, 100B, 1000 together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 1000. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 1000 can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 1000. Also, any of the network configurations 100A, 100B, 1000 can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 1000 can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 1001B, 1000, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 1000, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 1000 together. For example, the application 110 can perform similar functionality as the cloud 120, as well as coordinated functionality with the cloud 120.

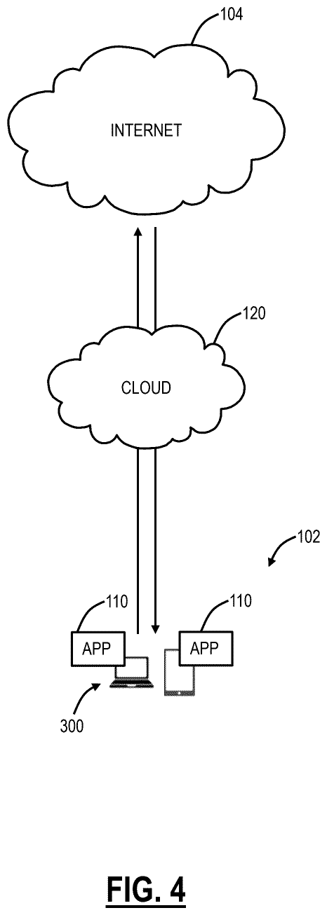

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Private Access System

As described, the cloud 120, i.e., the cloud-based system, is adapted to provide users of tenants with access to private applications via ZPA. The ZPA system can also be referenced herein as a private access system. The private access system is a cloud-based service designed to provide secure remote access to internal applications hosted in data centers, public clouds, or private clouds without the need for traditional VPNs. It leverages a zero-trust security model, meaning that no entity is trusted by default, whether inside or outside the network. The private access system ensures that users are only granted access to specific applications, rather than the entire network, significantly reducing the risk of lateral movement by potential attackers.

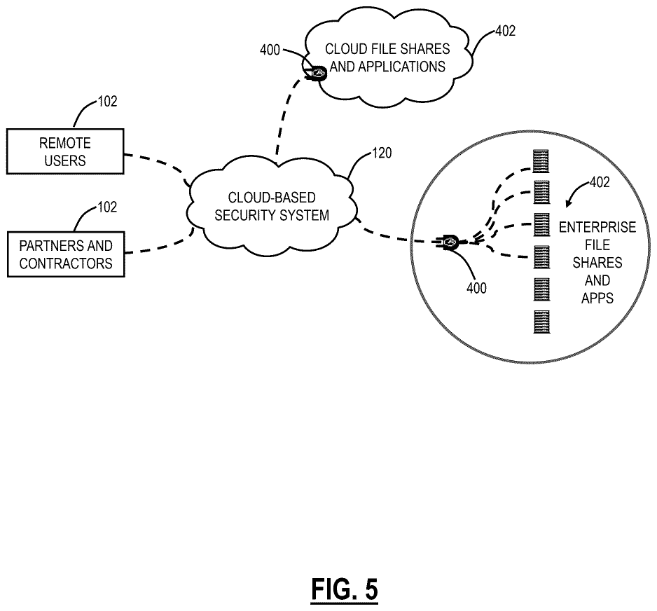

FIG. 5 is a flow diagram of an embodiment of the private access system. The service operates by establishing secure, outbound-only connections from the user's device to the cloud 120, where access policies are enforced. When a user 102 attempts to access an application 402, the private access system's policy engine verifies the user's identity, device posture, and context before granting access. This process involves an application connector 400, which sits in the same environment as the applications 402 and creates secure micro tunnels to the cloud 120, and the ZPA service edge, which brokers and secures the connection between the user 102 and the application 402.

Furthermore, the private access system enhances security by segmenting access at the application level, rather than the network level, ensuring that users can only see and access the applications they are authorized to use. This minimizes the attack surface and provides a streamlined, user-friendly experience without the need for cumbersome VPN connections. By continuously monitoring and enforcing policies, the private access system adapts to the changing security landscape, making it a robust solution for modern, distributed workforces.

Providing access to tenants through the private access system involves a systematic and secure process designed to facilitate controlled and efficient connectivity to internal applications. The process begins with infrastructure deployment, starting with the installation of the application connector 400 within the environment where the applications 402 reside, which could be data centers, public clouds, or private clouds. The application connector 400 creates secure, outbound-only connections to the cloud 120, ensuring no inbound connections to the network, thereby reducing the attack surface. Additionally, a service edge is deployed in the cloud 120 to act as an intermediary that brokers and secures connections between users and applications.

Next, administrators configure access policies in an admin portal, integrating user identities from identity providers such as Active Directory (AD), SAML, or other federated identity systems. These policies offer granular control, specifying which users or user groups can access particular applications based on roles, device posture, and contextual parameters like time and location. When a tenant user attempts to access an application 402, the agent application 110 or browser-based access method on their device initiates a connection to the cloud 120. The cloud 120 first authenticates the user's identity using the integrated identity provider to ensure only validated users can proceed. Concurrently, the device's security posture is evaluated to ensure compliance with organizational policies, which may include checks for antivirus status, Operating System (OS) version, and other security parameters.

Once the user is authenticated and the device posture is verified, the policy engine enforces the defined access policies, allowing only authorized users to proceed. The cloud 120 then dynamically establishes a secure micro tunnel from the user's device to the application connector 400 located in the environment where the application 402 resides, ensuring data security in transit through end-to-end encryption. Unlike traditional VPNs that provide broad network access, the private access system ensures that the user can only see and access the specific applications they are authorized to use, segmenting access at the application layer for added security.

The cloud 120, via the service edge, brokers and monitors the connection, maintaining its integrity and security throughout the session. Continuous policy enforcement ensures that any changes in user context or device posture are dynamically assessed to maintain compliance with security requirements. From the tenant user's perspective, the process is seamless, allowing access to applications 402 without the need for traditional, cumbersome VPN connections. By segmenting access at the application level and utilizing outbound-only connections, the private access system minimizes the risk of lateral movement within the network, significantly enhancing security posture. This detailed approach ensures that tenants have secure, reliable access to the applications they need while maintaining stringent security controls and minimizing potential attack vectors.

In an embodiment, a private access method implemented by the cloud 120, includes receiving a request to access resources from a computing device 300, wherein the resources are located in one of a public cloud and an enterprise network and the user device is remote therefrom on the Internet; forwarding the request to a central authority of the cloud 120 for a policy look up and for a determination of connection information to make an associated secure connection through the cloud 120 to the resources/resource; receiving the connection information from the central authority responsive to an authorized policy look up; and creating secure tunnels between the computing device 300 and the resources based on the connection information. Prior to the receiving, a user executes an agent application 110 on the computing device 300, provides authentication, and provides the request with the agent application 110 operating on the computing device 300. The agent application 110 can be configured to connect the device to the cloud 120, via an optimized cloud node based on the location of the device. The resources can be communicatively coupled to an application connector 400 operating on a computer and communicatively coupled between the resources and the cloud 120. The private access method can further include detecting the resources based on a query to the application connector 400. The application connector 400 can be prevented from accepting inbound connections, thereby preventing access of the resources external from the public cloud or the enterprise network. The creating secure tunnels can include creating connections between one or more cloud nodes in the cloud 120, wherein the one or more cloud nodes do not participate in a key exchange, and the one or more cloud nodes do not have data access to traffic on the secure tunnels. The creating secure tunnels can include creating connections between one or more cloud nodes in the cloud 120, wherein the one or more cloud nodes create the secure tunnels based on a combination of a client-side certificate and a server-side certificate. The secure tunnels can be created through software on the computing device, the cloud 120, and an application connector 400 operating on a computer associated with the resources, thereby eliminating dedicated hardware for virtual private network connections.

In another embodiment, a cloud 120 adapted to implement private access includes one or more cloud nodes communicatively coupled to one another; wherein each of the one or more cloud nodes includes one or more processors and memory storing instructions that, when executed, cause the one or more processors to receive a request to access resources from a computing device 300, wherein the resources are located in one of a public cloud and an enterprise network and the user device is remote therefrom on the Internet; forward the request to a central authority for a policy look up and for a determination of connection information to make an associated secure connection through the cloud 120 to the resources; receive the connection information from the central authority responsive to an authorized policy look up; and create secure tunnels between the computing device 300 and the resources based on the connection information.

### § 6.0 Delegated Tenant Administration

In large-scale environments with multiple customers/tenants, the complexity and scale of ZPA deployments often surpass the capacity of global administrators to manage everything efficiently. These global administrators seek to delegate specific administrative responsibilities to other administrators, who can oversee particular sections of users. This delegation is essential because the user base is typically segmented according to various criteria, such as authentication domains, SAML attributes, and SCIM attributes like country, department, and location. Tenants therefore require a robust mechanism to classify their users or clients based on these diverse attributes and subsequently assign dedicated administrators to manage them. This classification enables a more organized and manageable approach, ensuring that each group of users is overseen by administrators familiar with their specific needs and contexts. These delegated administrators are then responsible for creating and managing the necessary applications and policy rules tailored to the users or clients they oversee. This structured delegation not only enhances the efficiency of managing extensive user environments but also ensures that administrative tasks are handled with the appropriate level of detail and attention, maintaining security and operational efficacy across the board.

The present private access system incorporates Role-Based Access Control (RBAC) to enhance administrative management within the service. This feature allows organizations to configure and assign predefined or custom privileges to administrators, providing them with access to specific features in the private access admin portal based on their assigned roles. For example, one can create a role for an administrator that grants the rights to manage only policies. An administrator with such a role would be able to handle policy management but would be restricted from accessing other configuration areas such as application segments and application connectors 400. However, it is important to note that administrators with this role would have visibility into all policies configured within the tenant, as the current RBAC implementation does not support limiting policy management to a particular subset of policies.

In addition to RBAC, the private access system offers Delegated Tenant Administration (DTA), which allows organizations to grant different business units or internal organizations control over their designated portions of a private access tenant. Once a Micro Tenant (MT) is configured for a specific part of the larger organization, the administrators of that MT have the capability to set up and manage their own application segments, app connectors, and other components of the private access system configuration. This autonomy enables these administrators to achieve the necessary controls and outcomes tailored to their specific organizational needs. DTA thus empowers various internal groups within an organization to independently manage their segments of the ZPA environment, fostering a more efficient and customized administrative approach.

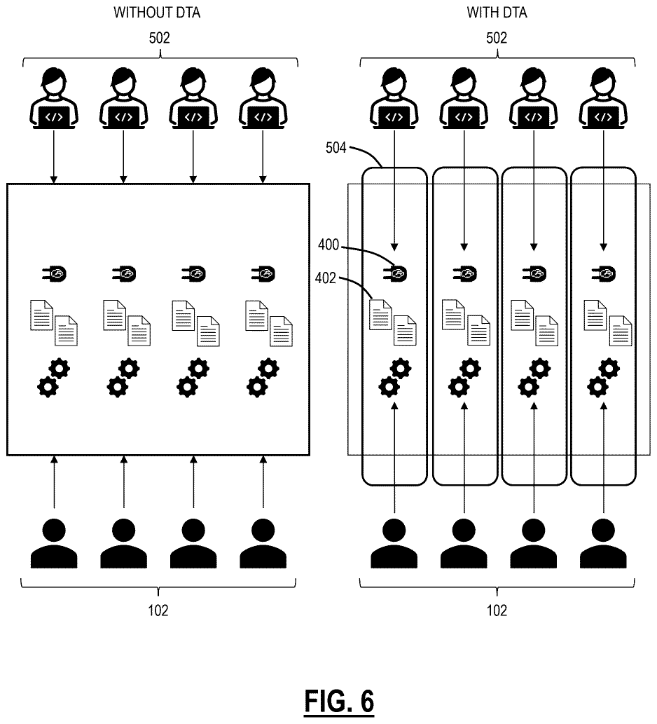

FIG. 6 is a diagram showing a tenant's administrative architecture with and without DTA. As can be seen, specific administrators 502 can be responsible for specific Micro Tenants (MTs) 504. That is, specific administrators 502 can have control over application connectors 400, applications 402, and configurations/policies within a specific MT 504.

DTA in the private access system offers several practical use cases that cater to the complex needs of large and dynamic organizations. One significant use case is for multinational organizations. These companies often involve multiple business units or subsidiaries spread across different geographical locations. With DTA, the central administration can delegate specific controls to these individual units, providing them with the autonomy to manage their own segments of the private access tenant. While administrators at the head office retain oversight over the activities of these business units, DTA empowers the units to independently handle their operational needs, leading to more efficient and localized management.

Another exemplary use case for DTA is during mergers and acquisitions (M&A). M&A activities typically involve integrating different Information Technology (IT) infrastructures and administrative practices. Through DTA, administrative rights can be delegated to specific administrators involved in the M&A process, including those from the acquiring company and the company being acquired. This delegation ensures that the transition is smoother and more controlled, as the involved administrators can independently manage their respective parts of the private access tenant while ensuring that security and operational policies are consistently maintained throughout the integration process. These use cases highlight how DTA provides tailored administrative capabilities, enhancing flexibility and control in complex organizational structures.

It is important to note that DTA does not replace the necessity for Role-Based Access Control (RBAC); rather, it complements it. When an MT is configured, administrators are assigned within that MT. Additional RBAC controls can be implemented to restrict the specific functions these MT administrators can perform based on their assigned roles. This layered approach allows for fine-grained administrative control over various parts of the private access system infrastructure, ensuring that each administrator has the appropriate level of access and responsibility.

Administrators within an MT have the responsibility to manage the configuration specific to their MT. This configuration is critical as it directly impacts the end users 102 within that MT. It is essential to ensure that end users are correctly mapped to their relevant MT so that they are subject to the appropriate configuration settings, such as consuming the correct application segments and policies. To achieve this precise mapping, the criteria for defining MTs should be based on the end user's authentication domains. By accurately aligning end users with their respective MTs, organizations can ensure that the users benefit from the correct set of configurations tailored to their needs, enhancing both security and operational efficiency.

| | Authentication | |
|---|---|---|
| MT Name | Domain | Description |
| MT-A | test1.com | End users with auth domain test1.com |
| | | will map to MT-A |
| MT-B | test2.com, | End users with auth domain test2.com |
| | test3.com | and test3.com will map to MT-B |

| MT Name | User Location | Description |
|---|---|---|
| MT-A | Geo-location 1 | End users in Geo-location 1 will map |
| | | to MT-A |
| MT-B | Geo-location 2, | End users in Geo-location 2 and Geo- |
| | Geo-location 3 | location 3 will map to MT-B |

In the private access system, scopes are categorized into two types: administrative and user. Within the administrative scope, there are two distinct roles: global admin and scope admin. The global admin, also known as the super admin, possesses comprehensive read/write access across the entire private access tenant. This role is crucial for making any necessary changes within the tenant, ensuring smooth operations. The responsibilities of the global admin include updating the tenant with changes to the Identity Provider (IDP), log receivers, and other critical infrastructure components required for daily operations.

Alternatively, the scope admin has read/write access over designated MTs within the private access system infrastructure. Although they have read access to tenant-wide functionalities such as IDP configuration, their primary control is over scope-specific resources within their assigned MTs. This delineation allows for targeted administrative control without compromising the broader tenant's integrity, ensuring focused and efficient management.

User scopes in the private access system are divided into a default scope or a specific MT scope, with users being mapped to only one scope or MT at a time. Users in the default scope can access only the resources assigned to the default tenant, typically used for general access without specific segmentation. Conversely, users mapped to a specific MT have access to the resources within that MT as well as the default tenant. This dual access allows for specialized resource consumption tailored to the user's needs within their specific MT. However, users scoped to a particular MT do not have access to resources in other MTs, ensuring a clear and secure separation of access privileges.

In summary, the structured approach to scopes in the private access system, both administrative and user, ensures that access and control are appropriately segmented and managed. This segmentation enhances security and operational efficiency, ensuring that administrators and users have the access they need without overstepping into areas beyond their designated scope.

| User | Default Tenant | MT-A | MT-B |
|---|---|---|---|
| Default User | ✓ | X | X |
| Tenant A User | ✓ | ✓ | X |
| Tenant B User | ✓ | X | ✓ |

Configuring DTA within the private access system involves several key steps to ensure proper segmentation and delegation of administrative responsibilities. The process begins with defining the organizational structure. This involves assessing the organization's structure to determine how different business units or internal organizations will be segmented within the private access tenant and identifying the parts of the organization that will be managed independently as MTs, which can be based on geographical locations, departments, or other logical divisions.

Next, one can create MTs by logging into the private access admin portal with global admin privileges and navigating to the section where MTs can be created and managed. A global admin can define a new MT by providing a name and relevant details that align with the identified organizational structure, then allocate resources and define the scope of the MT, including application segments, app connectors, and other essential configurations to be included.

Configuring RBAC involves creating roles that will be used within the MTs, with specific privileges tailored to the administrative needs within each MT. The global admin can assign these roles to the appropriate administrators within each MT, ensuring that they have the necessary permissions for managing the assigned resources while restricting access to other parts of the private access tenant.

Further, the global admin can assign administrators to MTs by identifying those who will manage the configuration and operations within each MT and assigning them to their respective MT in the private access admin portal, ensuring they have the roles and permissions necessary to perform their duties.

Policies and application segments can then be configured within each MT by defining the application segments that administrators will manage, specifying the applications and resources that fall under each segment, and creating policies that govern access to these application segments. The policies can align with the security and operational requirements of the specific MT.

From there, end users can be mapped to MTs by determining the criteria for mapping end users to their respective MTs, such as authentication domains, SAML attributes, or SCIM attributes like country, department, and location. The mapping can be implemented using the defined criteria to ensure that users are subject to the appropriate configurations and policies set within their assigned MT.

Finally, administrators can monitor and manage the activities and configurations within each MT regularly to ensure compliance with organizational policies and security standards. Configurations and policies can also be adjusted based on changing requirements or identified issues within the MTs. By following these steps, organizations can effectively configure DTA, ensuring that administrative responsibilities are properly segmented and managed. This approach enhances security, operational efficiency, and ensures that each part of the organization can autonomously manage its private access resources while maintaining overall oversight and control.

In the private access system, managing application access involves understanding how application segments are configured and inherited across tenants and MTs. By default, any application segment configured within the default tenant is automatically inherited by all MTs. This inheritance ensures that certain critical applications remain accessible to all users across the organization without requiring redundant configuration in each MT. For example, application segments can be defined in the default tenant if there are applications that need to be universally accessible to all users within the organization. This centralized approach simplifies management and ensures consistent access to essential applications.

Regarding policy application for default app segments, the policy lookup hierarchy in DTA follows a top-down approach. For an application segment defined in the default tenant, the system first looks for applicable policies within the default tenant. If no policy exists in the default tenant for that particular application segment, the system then performs a policy lookup within the relevant MT. For example, if an application segment named App_Seg_Default is defined in the default tenant, the system will initially search for policies governing App_Seg_Default in the default tenant. If such policies are not found, it will then look for applicable policies in the MT associated with the user accessing the application.

This hierarchical policy lookup ensures that default application segments benefit from a consistent primary policy set while allowing MTs the flexibility to apply additional policies as needed. This approach provides a balance between centralized control and decentralized flexibility, enhancing both security and operational efficiency across the organization.
there may be situations where users from one MT need to access one or multiple application segments from another MT. This is particularly relevant in scenarios where collaboration or specific access is required across different organizational units. To facilitate this, applications that reside within a MT can be shared with other MTs.

For example, consider a scenario where MT-1 has an application segment named App_Seg_MT1 that needs to be accessed by a group of users, such as the Contractor-Group, from MT-2. To enable this access, an administrator from MT-1 first shares the App_Seg_MT1 application segment with MT-2. Once the application segment is shared, the administrator in MT-2 must then create a policy that explicitly allows the Contractor-Group to access App_Seg_MT1. Similarly, applications that are associated with one MT can be moved or transferred to another MT by those MT administrators as described.

This process ensures that the necessary permissions are in place for cross-MT access while maintaining control and oversight within each MT. By sharing application segments and configuring appropriate policies, organizations can achieve seamless access and collaboration across different parts of the organization, enhancing productivity and operational efficiency. This capability is particularly useful for scenarios involving external contractors, cross-departmental projects, or any situation where selective access to applications across MTs is required.

Once an application segment is shared between MTs in the private access system, the administrator of the receiving MT assumes the responsibility of creating an access policy to enable access to the shared application segment. This step is crucial to ensure that the appropriate users within the receiving MT can access the application segment while maintaining security and control.

By taking on this responsibility, the administrator in the receiving MT ensures that access is properly managed and monitored. This process includes defining who can access the application segment, under what conditions, and ensuring that the access aligns with the organization's security policies and operational needs. The creation of such access policies by the receiving MT's administrator is a critical step in maintaining a secure and structured environment, allowing for seamless yet controlled access to shared application segments across different parts of the organization. This approach not only fosters collaboration and resource sharing but also upholds the integrity and security of the private access system infrastructure.

The DTA system in the private access service functions by allowing different parts of an organization, defined as MTs, to manage their own application access and security policies independently while still adhering to overarching administrative controls. The following outlines an embodiment of how the system operates when users of a tenant try to access applications.

When a user 102 attempts to access an application 402, the first step is to authenticate their identity using the organization's IDP. This ensures that only validated users 102 can proceed. Based on predefined criteria such as authentication domains, SAML attributes, or SCIM attributes (like country, department, or location), the user is then mapped to their respective MT. This mapping helps in determining the specific application segments and policies applicable to the user 102.

The system identifies the application segment the user is trying to access, which are defined sets of applications or services grouped together for management purposes. The DTA system uses a top-down policy lookup approach, beginning with the default tenant. If the application segment is defined in the default tenant, the system first looks for applicable access policies there. If no relevant policy is found, it then looks for policies in the user's assigned MT. The relevant access policy is applied based on this lookup, dictating whether the user has permission to access the requested application segment and under what conditions.

If users from one MT need to access application segments from another MT, the shared application segment must be properly configured. The administrator of the MT that owns the application segment shares it with the other MT. Once shared, the administrator of the receiving MT is responsible for creating and enforcing an access policy that allows their users to access the shared application segment, ensuring access is controlled and monitored according to the receiving MT's requirements.

Upon successful policy validation, a secure connection is established between the user's device and the application segment via the application connector 400, application 110, etc., encrypted to ensure data security during transit. The private access system continuously monitors the session, enforcing policies dynamically to adapt to any changes in user context or device posture, ensuring ongoing compliance and security.

While MT administrators manage their specific segments and policies, global admins maintain oversight across the entire tenant. They can update infrastructure components, manage IDPs, and ensure overall system health. Scope admins manage their designated MTs, having read/write access to specific resources within their scope, ensuring that policies and configurations align with their MT's operational needs.

In summary, the DTA system allows different organizational units to independently manage their application access and security policies while maintaining overall control and oversight. This decentralized approach enhances security, operational efficiency, and ensures that users have access to the applications they need, governed by appropriate policies and controls.

### § 6.1 Delegated Tenant Administration Process

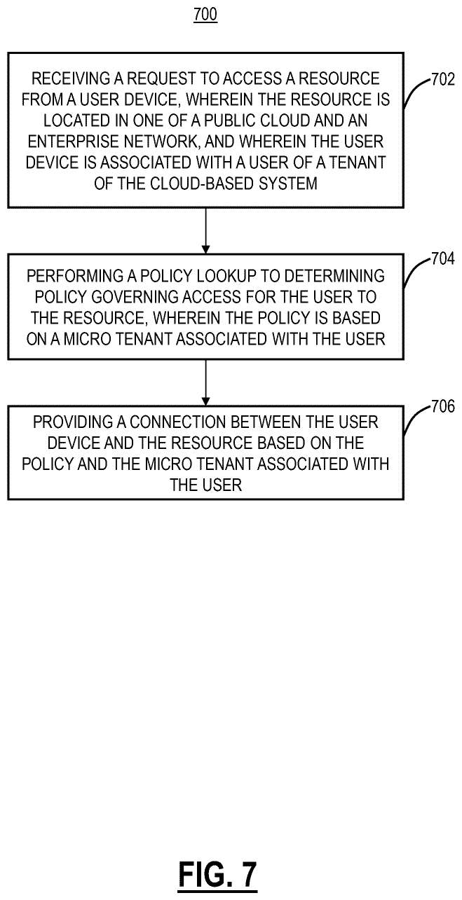

FIG. 7 is a flowchart of a process for delegated tenant administration in a cloud-based system. In various embodiments, the process 700 is contemplated as a method having steps, a processing device configured to implement the steps, a cloud-based system configured to implement the steps, and as a non-transitory computer-readable medium storing instructions for programming one or more processors to execute the steps. The process 700 includes receiving a request to access a resource from a user device, wherein the resource is located in one of a public cloud and an enterprise network, and wherein the user device is associated with a user of a tenant of the cloud-based system (step 702); performing a policy lookup for determining policy governing access for the user to the resource, wherein the policy is based on a micro tenant associated with the tenant (step 704); and providing a connection between the user device and the resource based on the policy and the micro tenant associated with the user (step 706).

The process 700 can further include determining a micro tenant to which the user belongs prior to the policy lookup. The tenant can include a plurality of micro tenants with a plurality of users assigned thereto, wherein each of the plurality of micro tenants includes specific resources and policies. Each of the plurality of micro tenants can be managed by a specific scope administrator, wherein a scope administrator is allowed to manage only a specific micro tenant of the plurality of micro tenants. The tenant can include a global admin, wherein the global admin is allowed to manage a default tenant and each of the plurality of micro tenants. The tenant can include a default tenant and a plurality of micro tenants, wherein the policy lookup is performed in a top-down manner. The connection can be provided via a private access service of the cloud-based system, wherein the connection is between an agent application executing on the user device and an application connector associated with the resource.

### § 7.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 8.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner-whether collectively, in subsets, or individually-thereby broadening the range of potential embodiments.

What is claimed is:

1. A method implemented by a cloud-based system, the method comprising steps of:
receiving a request to access a resource from a user device, wherein the resource is located in one of a public cloud and an enterprise network, and wherein the user device is associated with a user of a tenant of the cloud-based system;
performing a policy lookup to determining policy governing access for the user to the resource, wherein the policy is based on a micro tenant associated with the user; and
providing a connection between the user device and the resource based on the policy and the micro tenant associated with the user.

2. The method of claim 1, wherein the steps comprise determining a micro tenant to which the user belongs prior to the policy lookup.

3. The method of claim 1, wherein the tenant includes a plurality of micro tenants with a plurality of users assigned thereto, and wherein each of the plurality of micro tenants includes specific resources and policies.

4. The method of claim 3, wherein each of the plurality of micro tenants is managed by a specific scope administrator, and wherein a scope administrator is allowed to manage only a specific micro tenant of the plurality of micro tenants.

5. The method of claim 3, wherein the tenant includes a global admin, wherein the global admin is allowed to manage a default tenant and each of the plurality of micro tenants.

6. The method of claim 1, wherein the tenant includes a default tenant and a plurality of micro tenants, and wherein the policy lookup is performed in a top-down manner.

7. The method of claim 1, wherein the connection is provided via a private access service of the cloud-based system, and wherein the connection is between an agent application executing on the user device and an application connector associated with the resource.

8. A non-transitory computer-readable medium comprising instructions that, when executed, cause one or more processors of a cloud-based system to perform steps of:
receiving a request to access a resource from a user device, wherein the resource is located in one of a public cloud and an enterprise network, and wherein the user device is associated with a user of a tenant of the cloud-based system;
performing a policy lookup for determining policy governing access for the user to the resource, wherein the policy is based on a micro tenant associated with the user; and
providing a connection between the user device and the resource based on the policy and the micro tenant associated with the user.

9. The non-transitory computer-readable medium of claim 8, wherein the steps comprise determining a micro tenant to which the user belongs prior to the policy lookup.

10. The non-transitory computer-readable medium of claim 8, wherein the tenant includes a plurality of micro tenants with a plurality of users assigned thereto, and wherein each of the plurality of micro tenants includes specific resources and policies.

11. The non-transitory computer-readable medium of claim 10, wherein each of the plurality of micro tenants is managed by a specific scope administrator, and wherein a scope administrator is allowed to manage only a specific micro tenant of the plurality of micro tenants.

12. The non-transitory computer-readable medium of claim 10, wherein the tenant includes a global admin, wherein the global admin is allowed to manage a default tenant and each of the plurality of micro tenants.

13. The non-transitory computer-readable medium of claim 8, wherein the tenant includes a default tenant and a plurality of micro tenants, and wherein the policy lookup is performed in a top-down manner.

14. The non-transitory computer-readable medium of claim 8, wherein the connection is provided via a private access service of the cloud-based system, and wherein the connection is between an agent application executing on the user device and an application connector associated with the resource.

15. A cloud-based system comprising:
one or more processors; and
memory storing computer-executable instructions that, when executed, cause the one or more processors to:
receiving a request to access a resource from a user device, wherein the resource is located in one of a public cloud and an enterprise network, and wherein the user device is associated with a user of a tenant of the cloud-based system;
performing a policy lookup for determining policy governing access for the user to the resource, wherein the policy is based on a micro tenant associated with the user; and
providing a connection between the user device and the resource based on the policy and the micro tenant associated with the user.

16. The cloud-based system of claim 15, wherein the instructions further cause the one or more processors to determine a micro tenant to which the user belongs prior to the policy lookup.

17. The cloud-based system of claim 15, wherein the tenant includes a plurality of micro tenants with a plurality of users assigned thereto, and wherein each of the plurality of micro tenants includes specific resources and policies.

18. The cloud-based system of claim 17, wherein each of the plurality of micro tenants is managed by a specific scope administrator, and wherein a scope administrator is allowed to manage only a specific micro tenant of the plurality of micro tenants.

19. The cloud-based system of claim 17, wherein the tenant includes a global admin, wherein the global admin is allowed to manage a default tenant and each of the plurality of micro tenants.

20. The cloud-based system of claim 15, wherein the connection is provided via a private access service of the cloud-based system, and wherein the connection is between an agent application executing on the user device and an application connector associated with the resource.
